(19) United States
(12) Patent Application Publication
(10) Pub. No.: US 2025/0178222 A1
(43) Pub. Date: Jun. 5, 2025

(54) SCISSORS COMPRISING A SLIT

(71) Applicant: Heather Zager, Renton, WA (US)

(72) Inventor: Heather Zager, Renton, WA (US)

(21) Appl. No.: 18/963,439

(22) Filed: Nov. 27, 2024

Related U.S. Application Data
(60) Provisional application No. 63/605,300, filed on Dec. 1, 2023.

(51) Int. Cl. B26B 13/06; D05B 65/00

(52) U.S. Cl. CPC B26B 13/06; D05B 65/00

(57) ABSTRACT

Scissors comprising a slit are disclosed. The scissors may be used to cut or tear thread. In one embodiment, for example, the scissors comprise a first blade having an outer edge and a cutting edge, a second blade having a static edge positioned to engage the cutting edge of the first blade, and a slit in the first blade. The slit in the first blade extends toward a tip of the first blade and through a portion of the width of the first blade without extending therethrough. In operation, the scissors can be used to release a material from a machine by cutting thread attaching the material to the machine.

### CROSS-REFERENCE TO RELATED APPLICATIONS

This application claims the benefit of U.S. Provisional Patent Application 63/605,300 filed on Dec. 1, 2023, which is incorporated herein by reference in its entirety.

### TECHNICAL FIELD

The present technology generally relates to scissors and methods for manufacturing and using such devices.

### BACKGROUND

Sewing (or tailoring) scissors are used by seamstresses and tailors. Sewing scissors are designed with various aspects in mind, including handle comfort and ergonomics, size, weight, and blade durability. Depending on the type of stitching being done, a seamstress or tailor may choose a certain type of scissor. While there are several types of scissors designed specifically for particular types of fabric and/or stitching tasks, scissors designed to make sewing or tailoring more efficient are still needed.

### BRIEF DESCRIPTION OF THE DRAWINGS

FIGS. 1A and 1B are planar views of scissors configured in accordance with embodiments of the present technology.

FIGS. 2A-2C are close-up views of the scissors shown in FIGS. 1A and 1B.

FIG. 3 is an isometric view of the scissors shown in FIGS. 1A and 1B from the tip of the scissors.

FIGS. 4A and 4B illustrate the process by which the scissors shown in FIGS. 1A-3 can be used.

### DETAILED DESCRIPTION

The following disclosure is generally directed to scissors and methods for making and using such devices. The scissors may be any type of scissors used in sewing or tailoring, such as, for example, tailoring scissors, embroidery scissors, and duckbill scissors, among others. In one embodiment, for example, the scissors comprise a first blade having an outer edge and a cutting edge, a second blade having a static edge positioned to engage the cutting edge of the first blade, and a thread-receiving portion in the first blade. The thread-receiving portion in the first blade extends toward a tip of the first blade and through a portion of the width of the first blade without extending therethrough. The thread-receiving portion may be referred to herein as a slit or a channel.

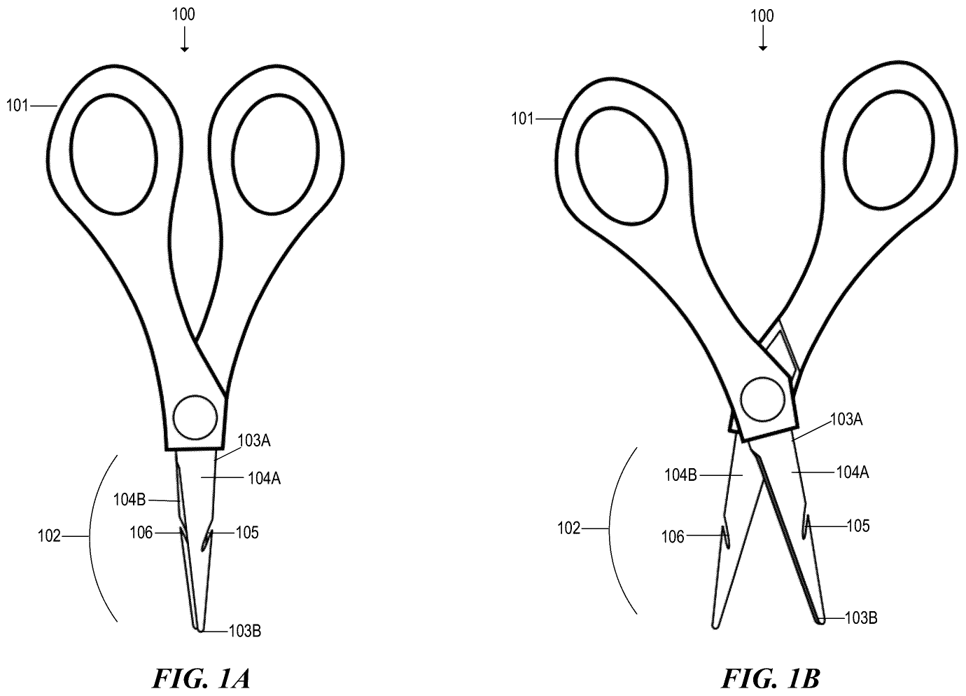

Certain details are set forth in the following description and in FIGS. 1A-4B to provide a thorough understanding of various embodiments of the present technology. Well-known structures, systems, and methods often associated with scissors and related apparatuses, however, have not been shown or described in detail below to avoid unnecessarily obscuring the description of the various embodiments of the present technology. Any dimensions, angles, and other specifications shown in the figures are merely illustrative of particular embodiments of the present technology. Accordingly, other embodiments of the technology can have other dimensions, angles, and specifications without departing from the spirit or scope of the present technology. In addition, those of ordinary skill in the relevant art will understand that additional embodiments of the present technology may be practiced without several of the details described below.

### Scissors and Associated Methods of Use

FIGS. 1A and 1B are planar views of scissors 100 configured in accordance with embodiments of the present technology. More specifically, FIG. 1A illustrates the scissors 100 in a closed configuration, and FIG. 1B illustrates the scissors in an open configuration. The scissors 100 include a handle portion 101 and a blade portion 102 coupled to the handle portion 101. The handle portion 101 may be configured with the stitcher's comfort and ease of use in mind. The configuration of the handle portion 101 is not limited herein. Likewise, the configuration of the blade portion 102 is not limited herein. For example, in some embodiments, the blade portion 102 comprises linear blades. In other embodiments, the blade portion 102 comprises non-linear blades (e.g., curved blades). Non-linear blades may be used for a particular type of sewing, such as, for example, embroidery. The blade portion 102 includes a base portion and a tip portion 103A and 103B. In the illustrated embodiment, the handle portion 101 is coupled to the blade portion 102 at the base portion 103A.

The handle portion 101 is preferably formed from a plastic or rubber material. The blade portion 102 is preferably formed from a metal material. In some embodiments, for example, the blade portion 102 is formed from titanium, steel, or stainless steel.

The blade portion 102 also includes a first blade 104A and a second blade 104B. In the closed configuration (FIG. 1A), the first blade 104A is depicted in front of the second blade 104B. The first blade 104A includes a slit 105, which is described in more detail below. In some embodiments, the slit 105 is a channel. In the illustrated embodiment, the second blade 104B also includes a slit 106. However, this is merely an example. In other embodiments, the second blade 104B does not include a slit.

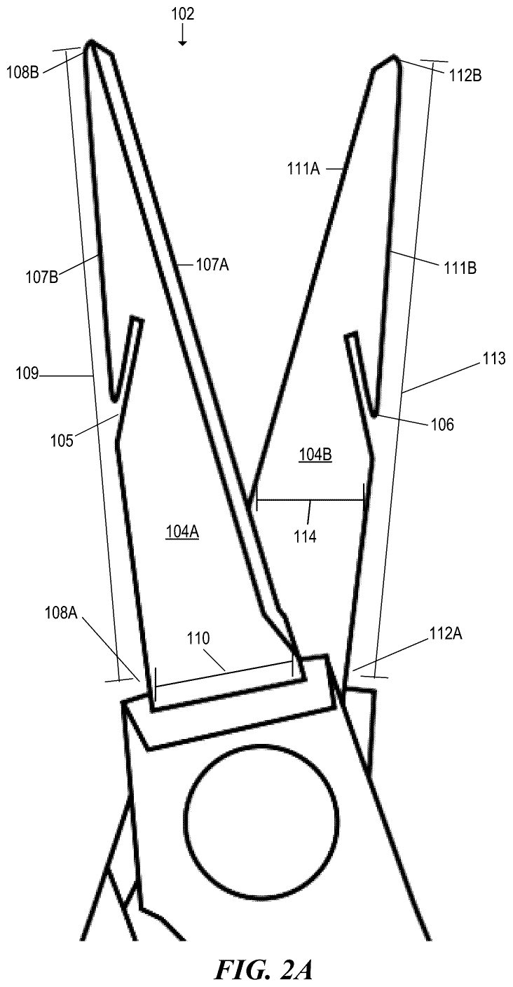

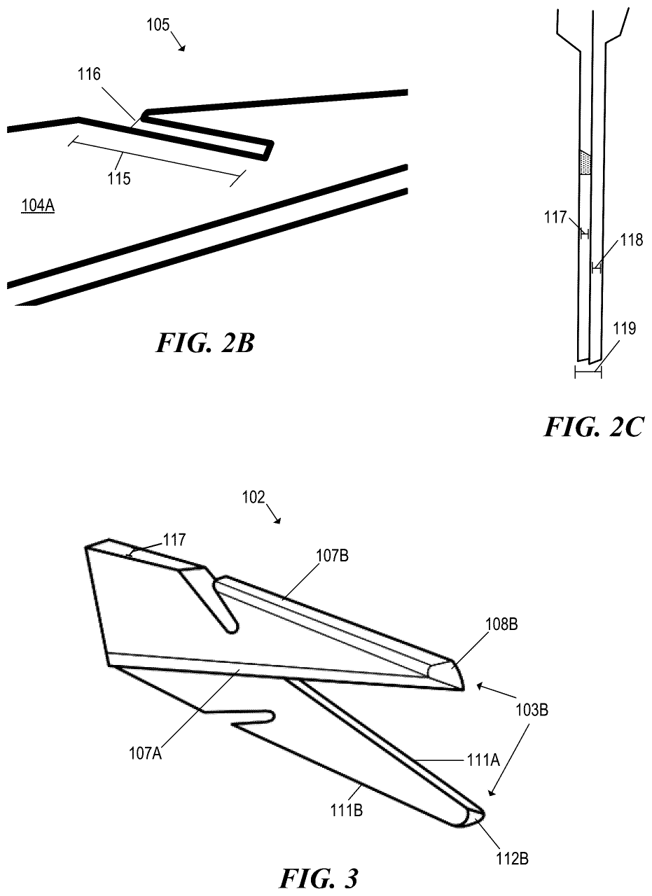

FIG. 2A is a close-up view of the blade portion 102 of the scissors 100. In FIG. 2A, the first blade 104A is depicted in front of the second blade 104B. The first blade 104A includes a cutting edge 107A and an outer edge 107B. The first blade 104A also includes a base portion 108A and a tip portion 108B. The first blade 104A may have a length 109, extending from the base portion 108A to the tip portion 108B. In some embodiments, for example, the length 109 can range from about 1.75 inches to about 4 inches. In other embodiments, however, the length 109 can vary. In some embodiments, the first blade 104A has a width 110 that narrows from the base portion 108A to the tip portion 108B. In some embodiments, for example, the width 110 at the base portion 108A ranges from about 0.25 inch to about 0.75 inch. In other embodiments, however, the width 110 can vary.

In the illustrated embodiment, the slit 105 of the first blade 104A extends toward the tip portion 108B of the first blade 104A and through a portion of the width of the first blade 104A without extending therethrough. In some embodiments, the slit 105 is positioned about two inches or less from the tip portion 108B of the first blade 104A. In other embodiments, however, the slit 105 is positioned about one inch or less from the tip portion 108B of the first blade 104A.

In some embodiments, the slit 105 of the first blade 104A has an angle relative to the outer edge 107B of the first blade 104A of less than about 90°. In some embodiments, the angle of the slit 105 relative to the outer edge 107B of the first blade 104A ranges from about 20° to about 90°, from about 20° to about 80°, from about 20° to about 70°, from about 20° to about 60°, or from about 20° to about 50°. In some embodiments, the angle of the slit 105 relative to the outer edge 107B of the first blade 104A ranges from about 30° to about 90°, from about 30° to about 80°, from about 30° to about 70°, from about 30° to about 60°, or from about 30° to about 50°. In some embodiments, the angle of the slit 105 relative to the outer edge 107B of the first blade 104A ranges from about 40° to about 90°, from about 40° to about 80°, from about 40° to about 70°, or from about 40° to about 60°.

The second blade 104B includes a static edge 111A and an outer edge 111B. The static edge 111A of the second blade 104B is positioned to engage with the cutting edge 107A of the first blade 104A. The term “static edge” is used for the purpose of illustration and is not meant to be overly limiting. In operation, the static edge 111A of the second blade 104B may be stationary or may move to engage the cutting edge 107A of the first blade 104A. In some embodiments, the static edge 111A is a cutting edge. In some embodiments, the static edge 111A remains stationary during use of the scissors 100. Alternatively, in some embodiments, the static edge 111A moves to engage with the cutting edge 107A of the first blade 104A. The second blade 104B also includes a base portion 112A and a tip portion 112B. The second blade 104B may have a length 113, extending from the base portion 112A to the tip portion 112B. The length 113 can range, for example, from about 1.75 inches to about 4 inches. In some embodiments, the length 113 of the second blade 104B is the same as the length 109 of the first blade 104A. In some embodiments, a width 114 of the second blade 104B narrows from the base portion 112A to the tip portion 112B of the second blade. At the base portion 112A of the second blade 104B, the width 114 may range, for example, from about 0.25 inch to about 0.75 inch. In some embodiments, the width 114 of the second blade 104B is the same as the width 110 of the first blade 104A. In other embodiments, however, the length 113 and/or the width 114 can vary.

In the illustrated embodiment, the second blade 104B includes a slit 106 extending toward the tip portion 112B of the second blade 104B and through a portion of the width of the second blade 104B without extending therethrough. In other embodiments, the second blade does not include a slit. In some embodiments, when the second blade 104B includes a slit 106, the slit 106 is positioned about two inches or less from the tip portion 112B of the second blade 104B. In other embodiments, however, the slit 106 is positioned about one inch or less from the tip portion 112B of the second blade 104B. When the first blade 104A and the second blade 104B each have a slit, the slits may be symmetrical.

FIG. 2B is a close-up view of the slit 105 of the first blade 104A. The slit 105 has a length 115 such that, when the scissors 100 are closed (see FIG. 1A), the static edge 111A of the second blade 104B intersects the slit 105 such that at least a portion (e.g., 0.0625 inch) of the length 115 of the slit 105 extends past the static edge 111A of the second blade 104B. In addition, the slit 105 has an opening dimension 116 spanning the width of the slit 105. The opening dimension 116 of the slit 105 may range, for example, from about 0.03125 inch to about 0.0625 inch.

FIG. 2C is a side view of the blade portion 102 of the closed scissors 100 (FIG. 1A). The first blade 104A of the scissors 100 has a thickness 117. In some embodiments, the thickness 117 of the first blade 104A ranges from, for example, about 0.03125 inch to about 0.0625 inch. The second blade 104B of the scissors 100 has a thickness 118. In some embodiments, the thickness 118 of the second blade 104B ranges from 0.03125 inch to about 0.0625 inch. In some embodiments, the thickness 118 of the second blade 104B is substantially the same as the thickness 117 of the first blade 104A. When the scissors are closed, the first and second blades, 104A and 104B, respectively, may have a combined thickness 119 of no more than 0.125 inch. In other embodiments, however, the thickness of the first blade 104A and/or the second blade 104B can vary.

FIG. 3 is an isometric view of the blade portion 102 of the scissors 100. As shown in FIG. 3, the outer edge 107B of the first blade 104A may be radiused. Likewise, the outer edge 111B of the second blade 104B may be radiused or curved. In some embodiments, the outer edge 107B of the first blade 104A and the outer edge 111B of the second blade 104B are both radiused or curved. Additionally, the cutting edge 107A of the first blade 104A and the static edge 111A of the second blade 104B may be sharp. The sharpness of the cutting edge 107A and the static edge 111A may depend on the type of material being cut. Further, in the illustrated embodiment, the tip portion 108B of the first blade 104A and the tip portion 112B of the second blade 104B are curved or rounded. In other embodiments, the tip portions (108B and 112B) of the first and second blades (104A and 104B), respectively, are pointed. Accordingly, when the scissors are closed, the tip portion 103B of the blade portion 102 may be curved or pointed.

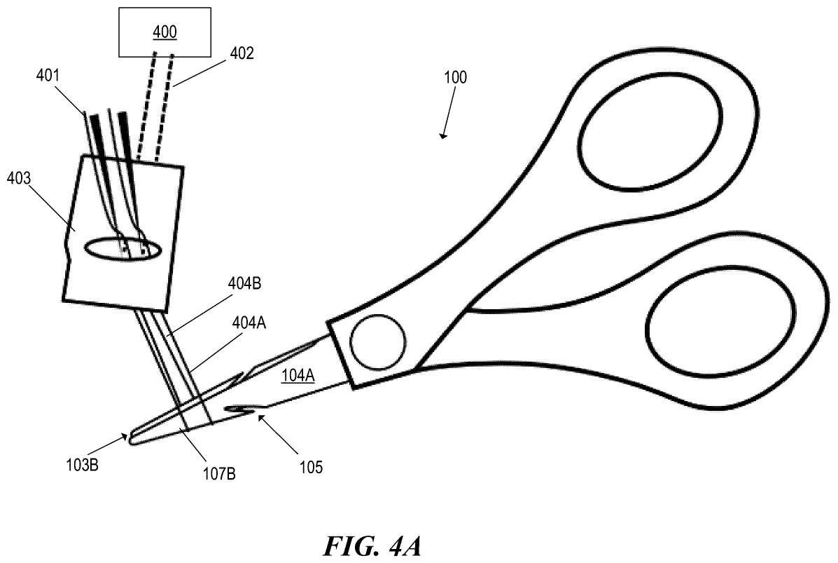

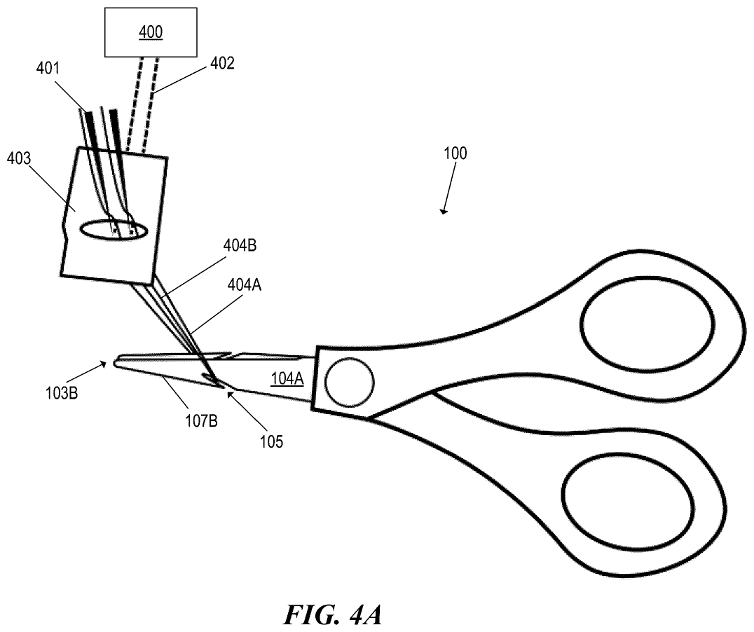

FIGS. 4A and 4B illustrate the process by which the scissors 100 can be used. In some embodiments, the scissors 100 are used to release a material from a machine by cutting the threads attaching the material to the machine. Specifically, the scissors 100 can be used to cut or tear thread having a first end 401 attached to a machine and a second end 402 attached to a material 400, where the thread is disposed between a presser foot 403 of the machine and the material 400. The machine may be any sewing machine commonly used in the art. Non-limiting examples of machines that may be used in the present method include domestic model sewing machines, industrial model sewing machines, hand operated sewing machines, treadle sewing machines, mechanical sewing machines, electronic sewing machines, computerized sewing machines, lockstitch machines, chain stitch machines, blind stitch machines, cover stitch machines, sergers, safety stitch machines, flat seam machines, bar tack sewing machines, button sewing machines, long arm quilting sewing machines, and embroidery only sewing machines. In some embodiments, the machine is a cover stitch machine. Likewise, the material 400 may be any material that may be sewed, stitched, or embroidered using a machine.

The closed scissors 100 can first be placed between the presser foot 403 and the material 400 to a side of the thread such that the thread is positioned against the outer edge 107B of the first blade 104A between the tip portion 103B of the scissors 100 and the slit 105. Then, the thread can be moved from between the presser foot 403 and the material 400 with the scissors 100, as depicted in FIG. 4A. A first portion of the thread 404A is disposed between the scissors 100 and the presser foot 403, and a second portion of the thread 404B is disposed between the scissors 100 and the material 400. The first portion 404A and the second portion 404B of the thread may be held taut with the scissors 100 once the thread is moved from between the presser foot 403 and the material 400.

As shown in FIG. 4B, after moving the thread from between the presser foot 403 and the material 400 with the scissors 100, the thread can be slid into the slit 105 of the first blade 104A. In some embodiments, the scissors 100 are used to cut the thread disposed in the slit 105. The scissors may be used to cut the thread by opening the scissors 100, such as, for example, by moving the second blade 104B from the first blade 104A such that the static edge 111A of the second blade does not intersect the length of the slit 105 of the first blade 104A, and then closing the scissors 100 such that the static edge 111A of the second blade 104B engages with, and cuts, the thread.

In other embodiments, the scissors 100 are used to tear the thread disposed in the slit 105. In such embodiments, the scissors 100 may remain closed. When the scissors 100 are closed, the static edge 111A of the second blade 104B may intersect with the slit 105 of the first blade 104A. To tear the thread, the tip portion 103B of the closed scissors 100 can be pointed toward the machine, and the scissors 100 can be pulled from the machine such that the thread tears on the static edge 111A of the second blade 104B. In some embodiments, the tip portion 103B of the scissors 100 is pointed toward the machine, and the scissors 100 are pulled from the machine simultaneously. In some embodiments, the tip portion 103B of the scissors 100 is first pointed toward the machine, and subsequently, the scissors 100 are pulled from the machine.

In the embodiments described above with reference to FIGS. 1A-4B, the disclosed scissors are configured to cut thread. In other embodiments, however, scissors configured in accordance with the present technology may be configured to cut rope, twine, wire, and the like.

Scissors of the present technology are described herein with respect to methods of tearing or cutting thread between a presser foot of a machine and a material and are therefore described with angles and dimensions for such purpose. However, scissors of the present technology may be used to cut or tear thread, rope, wire, twine, and the like between any machine, such as, for example, a machine that does not have a presser foot or one with a presser foot that is sized and shaped differently than those on a conventional sewing or embroidery machine, and a material, and as such, the dimensions and angles of the scissors may vary. For example, the first blade 104A and the second blade 104B of the scissors may have a length, width, and/or thickness outside of the ranges described above. More specifically, in some embodiments, the thickness of the first blade 104A and the second blade 104B is greater than 0.0625 inch. In some embodiments, the thickness of the first blade 104A and second blade 104B ranges from 0.0625 inch to about 0.1875 inch. In such embodiments, the combined thickness 119 of the first blade 104A and second blade 104B is no more than 0.375 inch. Likewise, the length of the first blade 104A and second blade 104B may be less than about 1.75 inches or greater than about 4 inches, and the width of the first blade 104A and the second blade 104B may be less than about 0.25 inch and greater than about 0.75 inch. A skilled artisan will appreciate the particular dimensions and angles of scissors required for a desired project/task.

### Examples

Several aspects of the present technology are set forth in the following examples.

1. Scissors comprising:
a first blade having a cutting edge and an outer edge;
a second blade having a static edge positioned to engage the cutting edge of the first blade; and
a slit in the first blade, the slit extending toward a tip of the first blade and through a portion of the width of the first blade without extending therethrough.

2. The scissors of example 1, wherein the slit has an opening dimension of from about 0.3125 inch to 0.0625 inch.

3. The scissors of any one of example 1 or example 2, wherein the static edge of the second blade intersects the slit such that at least 0.0625 inch of a length of the slit extends past the static edge of the second blade when the scissors are closed.

4. The scissors of any one of examples 1 to 3, wherein an opening of the slit is positioned on the first edge about two inches or less from the tip of the first blade.

5. The scissors of any one of example 4, wherein the opening of the slit is positioned on the first edge about one inch or less from the tip of the first blade.

6. The scissors of any one of examples 1 to 5, wherein the outer edge of the first blade is radiused or curved.

7. The scissors of any one of examples 1 to 6, wherein the first blade has a length ranging from about 1.75 inches to about 4 inches.

8. The scissors of any one of examples 1 to 7, wherein the second blade has a length ranging from about 1.75 inches to about 4 inches.

9. The scissors of any one of examples 1 to 8, wherein the length of the first blade is the same as the length of the second blade.

10. The scissors of any one of examples 1 to 9, wherein the first blade has a width ranging from about 0.25 inch to about 0.75 inch.

11. The scissors of any one of examples 1 to 10, wherein the second blade has a width ranging from about 0.25 inch to about 0.75 inch.

12. The scissors of any one of examples 1 to 11, wherein the width of the first blade is the same as the width of the second blade.

13. The scissors of any one of examples 1 to 12, wherein the first blade has a thickness ranging from about 0.03125 inch to about 0.0625 inch.

14. The scissors of any one of examples 1 to 13, wherein the second blade has a thickness ranging from about 0.03125 inch to about 0.0625 inch.

15. The scissors of any one of examples 1 to 14, wherein the thickness of the first blade is the same as the thickness of the second blade.

16. The scissors of any one of examples 1 to 15, wherein, when the scissors are closed, the first blade and the second blade together have a thickness of no more than 0.125 inch.

17. The scissors of any one of examples 1 to 16, wherein a tip of the first blade is rounded or pointed.

18. The scissors of any one of examples 1 to 17, wherein a tip of the second blade is rounded or pointed.

19. The scissors of any one of examples 1 to 18, wherein, when scissors are closed, a tip of the scissors is rounded or pointed.

20. A method of cutting thread with the scissors of any one of examples 1 to 19, the thread having a first end attached to a machine and a second end attached to a material, the thread being disposed between a presser foot of the machine and the material, the method comprising:
placing closed scissors between the presser foot and the material to a side of the thread such that the thread is positioned against the outer edge of the first blade between a tip of the scissors and the slit;
moving the thread from between the presser foot and the material with the scissors;
sliding the thread into the slit of the first blade;
opening the scissors; and cutting the thread disposed in the slit by closing the scissors such that the static edge of the second blade cuts the thread.

21. A method of tearing thread with the scissors of any one of examples 1 to 19, the thread having a first end attached to a machine and a second end attached to a material, the thread being disposed between a presser foot of the machine and the material, the method comprising:
placing closed scissors between the presser foot and the material to a side of the thread such that the thread is positioned against the outer edge of the first blade between a tip of the scissors and the slit;
moving the thread from between the presser foot and the material with the scissors;
sliding the thread into the slit of the first blade;
pointing the tip of the scissors toward the machine; and
pulling the scissors from the machine such that the thread tears on the static edge of the second blade.

22. The method of example 21, wherein the steps of pointing the tip of the scissors toward the machine and pulling the scissors away from the machine are carried out simultaneously.

23. A method of releasing a material from a machine, the method comprising cutting the threads attaching the material to the machine with the scissors of any one of examples 1 to 19.

24. Scissors comprising:
a first blade having a cutting edge and an outer edge;
a second blade having a static edge positioned to engage the cutting edge of the first blade; and
a channel in the first blade, the channel extending toward a tip of the first blade and through a portion of the width of the first blade without extending therethrough.

### CONCLUSION

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. Moreover, the various embodiments described herein may also be combined to provide further embodiments. Additionally, although many of the embodiments are described with respect to scissors for cutting or tearing thread, it should be noted that other applications and embodiments, in addition to those disclosed herein, are within the scope of the present technology. For example, the disclosed scissors can be used to cut or tear other items such as rope, twine, wire, fabric, etc. Further, the disclosed scissors can also be used, for example, to cut electrical wire, trim hedges, or remove stitches.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Where the context permits, singular or plural terms may also include the plural or singular term, respectively. Additionally, the term “comprising” is used throughout to mean including at least the recited feature(s) such that any greater number of the same feature and/or additional types of other features are not precluded. It will also be appreciated that specific embodiments have been described herein for purposes of illustration but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. Scissors comprising:
a first blade having a cutting edge and an outer edge;
a second blade having a static edge positioned to engage the cutting edge of the first blade; and
a slit in the first blade, the slit extending toward a tip of the first blade and through a portion of the width of the first blade without extending therethrough.

2. The scissors of claim 1, wherein the slit has an opening dimension of from about 0.3125 inch to 0.0625 inch.

3. The scissors of claim 1, wherein the static edge of the second blade intersects the slit such that at least 0.0625 inch of a length of the slit extends past the static edge of the second blade when the scissors are closed.

4. The scissors of claim 1, wherein an opening of the slit is positioned on the first edge about two inches or less from the tip of the first blade.

5. The scissors of any one of claim 4, wherein the opening of the slit is positioned on the first edge about one inch or less from the tip of the first blade.

6. The scissors of claim 1, wherein the outer edge of the first blade is radiused or curved.

7. The scissors of claim 1, wherein the first blade and the second blade each have a length ranging from about 1.75 inches to about 4 inches.

8. The scissors of claim 1, wherein the length of the first blade is the same as the length of the second blade.

9. The scissors of claim 1, wherein the first blade and the second blade each have a width ranging from about 0.25 inch to about 0.75 inch.

10. The scissors of claim 1, wherein the first blade and the second blade each have a thickness ranging from about 0.03125 inch to about 0.0625 inch.

11. The scissors of claim 1, wherein the thickness of the first blade is the same as the thickness of the second blade.

12. The scissors of claim 1, wherein, when the scissors are closed, the first blade and the second blade together have a thickness of no more than 0.125 inch.

13. The scissors of claim 1, wherein a tip of the first blade is rounded or pointed.

14. The scissors of claim 1, wherein a tip of the second blade is rounded or pointed.

15. The scissors of claim 1, wherein, when scissors are closed, a tip of the scissors is rounded or pointed.

16. A method of cutting thread with the scissors of claim 1, the thread having a first end attached to a machine and a second end attached to a material, the thread being disposed between a presser foot of the machine and the material, the method comprising:
placing closed scissors between the presser foot and the material to a side of the thread such that the thread is positioned against the outer edge of the first blade between a tip of the scissors and the slit;
moving the thread from between the presser foot and the material with the scissors;
sliding the thread into the slit of the first blade;
opening the scissors; and
cutting the thread disposed in the slit by closing the scissors such that the static edge of the second blade cuts the thread.

17. A method of tearing thread with the scissors of claim 1, the thread having a first end attached to a machine and a second end attached to a material, the thread being disposed between a presser foot of the machine and the material, the method comprising:
placing closed scissors between the presser foot and the material to a side of the thread such that the thread is positioned against the outer edge of the first blade between a tip of the scissors and the slit;
moving the thread from between the presser foot and the material with the scissors;
sliding the thread into the slit of the first blade;
pointing the tip of the scissors toward the machine; and
pulling the scissors from the machine such that the thread tears on the static edge of the second blade.

18. The method of claim 17, wherein the steps of pointing the tip of the scissors toward the machine and pulling the scissors away from the machine are carried out simultaneously.

19. A method of releasing a material from a machine, the method comprising cutting the threads attaching the material to the machine with the scissors of claim 1.

20. Scissors comprising:
a first blade having a cutting edge and an outer edge;
a second blade having a static edge positioned to engage the cutting edge of the first blade; and
a channel in the first blade, the channel extending toward a tip of the first blade and through a portion of the width of the first blade without extending therethrough.
